(19) United States
(12) Patent Application Publication
(10) Pub. No.: US 2023/0004546 A1
(43) Pub. Date: Jan. 5, 2023

(54) DATA MANAGEMENT

(71) Applicant: Cogniflare Limited, London (GB)

(72) Inventors: Sivakumaran Ayanarappan MOUNIDEVY, Chelmsford (GB); Ahamed Hussainkhan AJMALKHAN, Morden (GB)

(21) Appl. No.: 17/365,790

(22) Filed: Jul. 1, 2021

(51) Int. Cl. G06F 16/23; G06F 16/21; G06F 16/2457; G06F 16/26

(52) U.S. Cl. CPC G06F 16/2358; G06F 16/211; G06F 16/24573; G06F 16/26

(57) ABSTRACT

A computer-implemented method is provided for managing data stores. The method comprises performing a discovery process to discover a plurality of data stores. Each data store is identified, metadata associated with each data store is determined, and the metadata associated with each data store is stored in a configuration database. A user interface is operable to select at least one discovered and identified data store and initiate a change request to modify the selected data store. The change request is executed, based on an instruction received via the user interface, to modify the selected data storage set, and, upon execution of the change request, an update of the metadata in the configuration database associated with the selected data storage set is triggered.

### BACKGROUND OF THE INVENTION

### Field of the Invention

This invention relates generally to the field of data management, and more particularly to data exploration, governance and permission management.

### Description of the Related Technology

Increased use of cloud-based data storage has brought with it numerous challenges for enterprises handling large quantities of data. In particular, enterprises dealing with multiple data storage assets spread across a number of locations in a cloud environment, such as Google Cloud, face challenges relating to finding the relevant data, security and access permissions, and efficiency in providing the data to the relevant users.

As an example, if one entity within an organization requires access to a particular data set, methods currently known in the art would require separate processes be initiated to find the dataset, identify the owner of the dataset, request access to the dataset, and grant access to the dataset. Multiple teams and personnel, including the data owner, security reviewers, privacy reviewers and audit teams would be required to engage in action, even though only one access request needs to be granted. All these separate processes lack integration and rely on personnel manually verifying various permissions and authorization, increasing the lead time on data provisioning requests and decreasing the efficiency of the cloud-based storage services.

A more efficient method for managing data assets is therefore desirable.

### SUMMARY

According to a first aspect there is provided a computer-implemented method for managing data stores performed by an information-processing apparatus, the method comprising: performing a discovery process to discover a plurality of data stores; identifying each data store and determining metadata associated with each data store; storing the metadata associated with each data store in an application database; providing a user interface operable to select at least one discovered and identified data store and initiate a change request to modify the metadata associated with the selected data store; executing the change request, based on an instruction received via the user interface, to modify the metadata associated with the selected data store; and upon execution of the change request, triggering an update of the metadata in the application database associated with the selected data store.

According to a second aspect there is provided an information processing apparatus comprising: a processor, and a storage that stores instructions that, when executed by the processor, cause the processor to perform a method comprising: performing a discovery process to discover a plurality of data stores; identifying each data store and determining metadata associated with each data store; storing the metadata associated with each data store in an application database; providing a user interface operable to select at least one discovered and identified data store and initiate a change request to modify the metadata associated with the selected data store; executing the change request, based on an instruction received via the user interface, to modify the metadata associated with the selected data store; and upon execution of the change request, triggering an update of the metadata in the application database associated with the selected data store.

According to a third aspect there is provided a non-transitory computer-readable storage medium storing instructions that, when executed by a computer, cause it to perform a method comprising: performing a discovery process to discover a plurality of data stores; identifying each data store and determining metadata associated with each data store; storing the metadata associated with each data store in an application database; providing a user interface operable to select at least one discovered and identified data store and initiate a change request to modify the metadata associated with the selected data store; executing the change request, based on an instruction received via the user interface, to modify the metadata associated with the selected data store; and upon execution of the change request, triggering an update of the metadata in the application database associated with the selected data store.

### BRIEF DESCRIPTION OF THE DRAWINGS

Embodiments will now be described with reference to the accompanying drawings in which:

FIG. 1 is a schematic diagram of an exemplary cloud storage system;

FIG. 2 is a flow chart showing the steps of a process by which a user requests access to a data storage asset;

FIG. 3 is an example of a user interface presented to a user;

FIG. 4 is a flow chart showing the steps of a process by which a change request is initiated, approved and executed;

FIG. 5a is a flow chart showing the steps of a process by which a database is deployed to an environment;

FIG. 5b is an illustration of a user interface for deploying a data model;

FIG. 6 is an example of a data storage map; and

FIG. 7 is a schematic diagram of a software architecture.

### DETAILED DESCRIPTION OF CERTAIN INVENTIVE EMBODIMENTS

Before discussing particular embodiments with respect to the figures, some more general embodiments will be described.

A first embodiment provides a computer-implemented method for managing data assets performed by an information-processing apparatus, the method comprising: performing a discovery process to discover a plurality of data stores; identifying each data store and determining metadata associated with each data store; storing the metadata associated with each data store in an application database; providing a user interface operable to select at least one discovered and identified data store and initiate a change request to modify the metadata associated with the selected data store; executing the change request, based on an instruction received via the user interface, to modify the metadata associated with the selected data store; and upon execution of the change request, triggering an update of the metadata in the application database associated with the selected data store.

The user interface may be generated based on metadata stored in the application database, whereby the user interface is operable to select at least one discovered and identified data store and initiate a change request to modify the selected data store.

The metadata associated with each data store may comprise at least one of: permission data, schema data and policy data. In embodiments in which the metadata is permission data, the permission data may be managed by a permissions service that manages access permissions to the data store. In other embodiments, the permission data may be managed as part of the data store. For example, if the information processing apparatus hosts a cloud service, the cloud service may provide a permissions service to manage access to data stores. In other implementations the data store may be a database and the permissions may be stored and managed by database software managing the database.

The change request may comprise an access request to change access permissions for accessing the data store.

The instruction received via the user interface may trigger an approval process prior to execution of the change request.

The approval process may comprise causing one or more review requests to be sent to one or more approvers. The method may comprise tracking receipt of one or more approvals in response to the one more review request. In a case that one or more approval is received to complete the approval process, the change request may be executed.

The change request may be stored in the application database until the approval process is completed.

The method may comprise creating groups of discovered and identified data stores based on users having access to the data store in question.

The method may comprise generating a storage map of the discovered and identified data stores for display on a user interface. Generating the storage map may comprise analysis usage logs associated with each data store and illustrating relative usage of the data stores on the storage map.

The user interface may be operable to receive instructions to cause deployment of a data model to an environment. In such cases, the deployment of the data model to the environment may comprise importing a physical data model. The method may comprise receiving selection of a database to which the physical data model will be applied. The model may further comprise receiving selection of at least one environment to which the database will be deployed. The method may comprise deploying a database to the selected environment in accordance with the selected dataset, the physical data model and the database schema. In some embodiments, the method may further comprise migrating the database schema of a database that has been deployed by applying a new data model to the database.

Performing the discovery process may comprise interrogating a data catalog.

The method may further comprise changing locations in which the data stores are located in response to an instruction from a user. The data store locations may be categorized into storage tiers according to storage duration. The method may comprise moving data stores to data store locations in different storage tiers in response to a user request.

The method may further comprise receiving an instruction defining a rule relating to metadata associated with at least one of the plurality of data stores, and comparing the discovered metadata associated with the at least one of the plurality of data stores with the defined rule.

A second embodiment provides an information processing apparatus comprising: a processor, and a storage that stores instructions that, when executed by the processor, cause the processor to perform a method comprising: performing a discovery process to discover a plurality of data stores; identifying each data store and determining metadata associated with each data store; storing the metadata associated with each data store in an application database; providing a user interface operable to select at least one discovered and identified data store and initiate a change request to modify the metadata associated with the selected data store; executing the change request, based on an instruction received via the user interface, to modify the metadata associated with the selected data store; and upon execution of the change request, triggering an update of the metadata in the application database associated with the selected data store.

A third embodiment provides a non-transitory computer-readable storage medium storing instructions that, when executed by a computer, cause it to perform a method comprising: performing a discovery process to discover a plurality of data stores; identifying each data store and determining metadata associated with each data store; storing the metadata associated with each data store in an application database; providing a user interface operable to select at least one discovered and identified data store and initiate a change request to modify the metadata associated with the selected data store; executing the change request, based on an instruction received via the user interface, to modify the metadata associated with the selected data store; and upon execution of the change request, triggering an update of the metadata in the application database associated with the selected data store.

Particular embodiments will now be described, with reference to the figures.

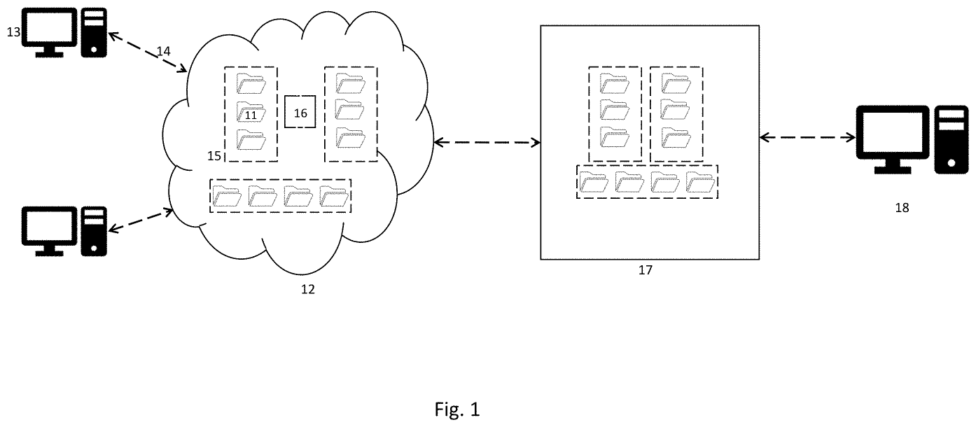

FIG. 1 is a schematic diagram showing an overview of a cloud-based storage system. Data stores in the form of data storage assets 11 are stored in a cloud environment 12. A data storage asset may be a database, structured files such as Excel files, semi-structured files such as CSV (Comma-Separated Value) files, unstructured files such as a blob of data, or any other data storage format. Data within the cloud environment 12 is accessible by client computers 13 across a network connection 14, by other machines within the cloud environment 12, servers 18 outside of the cloud environment, or from other cloud services 17. The network connection 14 may be the internet. Access to each data storage asset 11 is controlled in dependence upon access permissions set by the owner of the data storage asset 11 or by another user with the relevant authority. Data storage assets 11 may be stored in different groupings 15 within the cloud environment. The groupings 15 may depend on ownership or may be based on use within an entity such as a company. A data management software package 16, hereinafter referred to as data management software, is shown in FIG. 1. The data management software runs in the cloud environment 12. Functions of the data management software 16 will now be described.

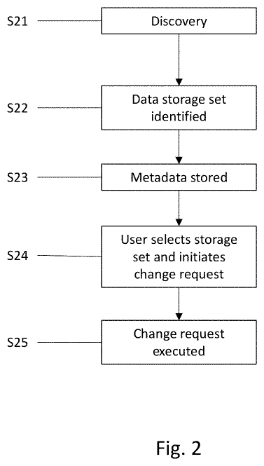

FIG. 2 is a flowchart showing steps of a method for managing data performed by the data management software 16. In Step S21, a discovery process is initiated, to locate specific data storage assets 11 within the cloud environment 12. In this step, each individual data storage asset 11 belonging to a given entity may be found and located within the wider cloud storage environment 12. In some embodiments, this discovery may be performed by a crawler (sometimes referred to as an indexer) of the data management software 16, systematically browsing the cloud environment 12 to locate data storage assets 11. Locating these data storage assets 11 also allows for them to be categorized and identified. In other embodiments, the cloud service may provide a discovery function and discovery by the data management software 16 may comprise interrogating the cloud service via an API or other interface. A particular example on Google Cloud™ would be interrogating Google Data Catalog. In such embodiments, the results of the interrogation may be enriched with additional metadata not obtained from the discovery function provided by the cloud service. This additional metadata may be obtained by a crawler of the data management software 16 as described above.

In this embodiment, discovery of data stores within the cloud environment 12 will be described. However, in other embodiments, discovery of data stores may take place across multiple cloud environments 12 and 17 and/or be performed on one or more servers 18.

In Step S22, identification of the data storage assets 11 occurs. For each data storage asset discovered in S21, the metadata of that asset is obtained by interrogating the data storage asset 11 in order to accurately identify and categorize the data storage assets 11. This metadata may include information such as the asset's name, description, columns definitions, permission data, schema data and policy data. In step S23, the metadata determined for each data storage asset is then stored in an application database that forms part of the data management software 16. An index is created based on the metadata of the data storage assets 11, with every data storage asset 11 represented in one unified list or other index representation. This index can be easily searched in response to a query by a user to find a specific data storage asset 11, rather than the user being required to manually search through the cloud environment 12 on their own. The application database is updated on a continuous basis, with the cloud environment 12 being scanned frequently to ensure an accurate index. As described above, in some embodiments, an external data catalog provided within a cloud environment 12 may be used to store an index of multiple data storage assets 11, some of which may be relevant to the instance of the data management software 16 and some of which may not. In order to discover data storage assets 11 relevant to the instance of the data management software 16, the discovery process S21 may comprise crawling the data catalog and importing the relevant identified data storage assets 11 to be stored in the application database.

In order to allow the user to search for and select data storage assets 11, in step S24 a user interface is presented to the user. This user interface allows the user to search for a particular data storage asset 11. Once found, a representation of the data storage asset 11 on the user interface may be selected for an access request. An access request may be triggered by a user “checking out” the data storage asset 11 using the user interface, which adds the asset in question to a list of assets that will be subject to a change request. In this embodiment, selecting a representation of the data storage asset 11 within the user interface and checking the data storage asset out in this manner marks the data storage asset 11 as being a potential subject for an access request.

Once the user has selected one or more data storage assets 11 to which they wish to request access, completing the checkout process on the user interface causes an access request to be initiated. This access request is a form of change request, as it requests a modification of the properties of the selected data storage asset—specifically, it requests a modification in the access permissions of the selected data storage asset 11 to allow the user to access the data contained therein. In embodiments wherein the data storage assets are stored in on-premises servers, the access request may directly alter the permissions metadata associated with the data storage asset. In embodiments wherein the data storage assets are cloud-based, the access request may only request access, with the granting of access and alteration of permissions metadata being provided as a service.

In step S25, the access request initiated in response to the user instructions in step S24 is executed. The execution of the access request triggers an update of the permissions metadata of the data storage asset 11 to which access was requested—the permissions metadata is updated to reflect the changed access permissions, showing that the user has been granted access to the asset as a result of the execution of the access request.

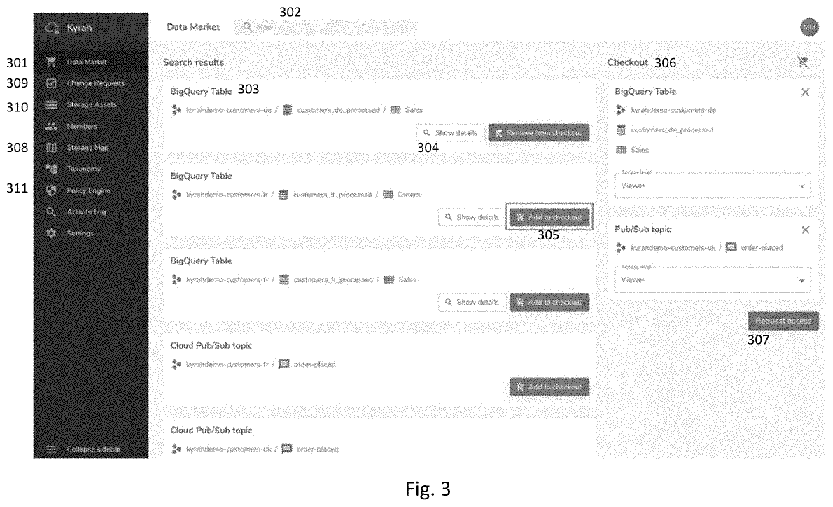

FIG. 3 shows an example of a user interface of the type described in relation to FIG. 2. Looking at the navigation panel on the left-side of the user interface, the ‘Data Market’ function 301 allows the user to access the index of data storage assets created in S23, with the search bar 302 providing the user with the capacity to search the index for particular data storage assets 11. The representations 303 of the data storage assets corresponding to a particular search are displayed to the user, with the option available to display further details relating to each data storage asset 11 using the selector 304. Data storage assets 11 may be selected for ‘checkout’ using the selector 305 as described previously, this ‘checkout’ marks the data storage asset 11 in question as a potential subject for an access request. Doing so additionally causes a representation of a data storage asset thus selected to be displayed in the ‘checkout’ column 306 on the right-side of the user interface shown in FIG. 3.

Once a user has selected a data storage asset 11 for ‘checkout’, the user may then request access to this data storage asset 11 through the user interface, using the selector 307. Selection of the selector 307 triggers initiation of an access request.

Further functions may be presented by the user interface, some of which are described below in relation to later figures and further embodiments. ‘Storage Map’ function 308, shown on the left-side navigation panel, allows the viewing of a map of data storage assets 11 shown in the user interface. The map of the data storage assets 11 may be generated by the data management software package 16. ‘Change Request’ function 309 enables visualization, approval, rejection or cancellation of change requests. ‘Storage Asset’ function 310 enables an overview of all storage assets and also allows storage assets to be edited, created or deleted, as well as allowing storage assets to be grouped together. ‘Policy Engine’ function 311 allows a user to set up rules governing data storage assets. One example of a rule is that a particular asset may only be accessed by users within a certain geographical area. This function further enables the monitoring of activity across data storage assets, reporting on rule violations and suggesting corrections to the rule violations.

The person having ordinary skill in the art will appreciate that the specific labels used in this example are provided by way of example only, and that as they have little bearing on the technical functioning of the system, should not be construed as limitations.

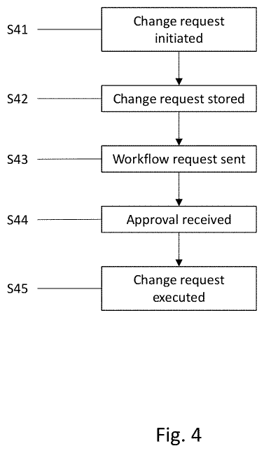

FIG. 4 is a flowchart showing steps for processing a change request. In this example the change request, that was initiated in response to an instruction received via the user interface, is not automatically executed upon initiation by the user, but requires completion of an approval workflow in order to be executed. In step S41, the change request is initiated. This may be performed as described in previous paragraphs—the user may search for and locate a data storage asset using the user interface, select the data storage asset as the subject of a change request and, using the selector 307 present in the user interface provided to the user, request access to one or more data storage assets 11.

In Step S42, as the change request is not executed until the approval workflow is completed and the change is approved, the change request is stored in the application database. The request is held in the application database until the approval workflow is completed and may be stored thereafter for auditing purposes. Following this, in Step S43, an approval process is initiated. This approval process may take the form of one or more review requests being sent to users who have been designated to authorize access to the discovered data storage assets 11. Depending on the workflow configuration, different approvals may be required. The request may be able to be approved by any user other than the requesting user, provided they have the appropriate permissions in the data management software 16. Requests may only be able to be approved by a resource owner assigned to the data storage asset 11 to which the change request applies. The resource owner may be an explicitly assigned group or user, or—where no group or user is assigned—may be a default owner. If there is no resource owner or default owner assigned to the data storage asset 11, the request cannot be executed without an owner first being assigned. The request may also be subject to hierarchical approval—in this case, approval must be granted by a user assigned as the approver or manager of the requesting user. If no approver is assigned to the requesting user, the request cannot be executed.

The review request may be sent by email to the approver, text message to a mobile device of the approver, or by any other suitable communication process. The review request may be approved or rejected by logging in to the data management software 16 and approving or rejecting the review request respectively. The review request may, for example, include a hyperlink back to the data management software 16 that, when activated, causes the data management software 16 to update to indicate that approval has been received.

Once the review request has been sent to the relevant individual, in step S44 the system tracks the receipt of the requisite approvals—i.e. the approval is monitored to determine whether or not the required approvals have been received in response to the review request sent in Step S43. Once the required approval or all the required approvals have been received, in step S45 the change request is executed. As above, this change request may involve a modification to the data storage asset 11 itself, or may be an access request, meaning that the modification is to the access permissions of the data storage asset 11.

The workflow described in connection with FIG. 4 has been described in connection with a change request for access to a data storage asset. However, the workflow process may be used for any change requested through the data management software 16, for example workflow approval could be required for deployment of a data model as described further below.

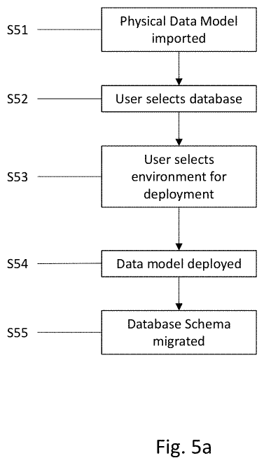

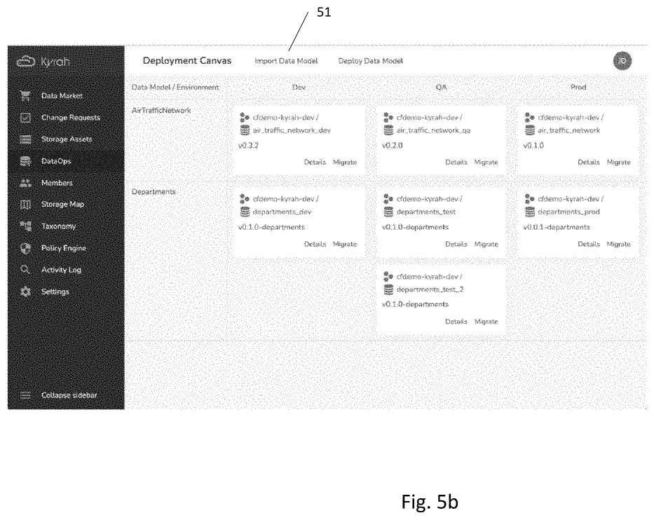

In a further embodiment, the data management software 16 described herein may additionally provide users with the capability to deploy data models within the data management software 16 so that they can be viewed on the user interface shown in FIG. 5b. The user can then manage database schemas associated with data storage assets 11 that have been deployed. FIG. 5a is a flow chart showing steps for deploying a data model to an environment within the data management software. FIG. 5b is an illustration of a user interface showing deployed data models.

In Step S51, a user selects an option 51 in the user interface shown in FIG. 5b to import a physical data model. This physical data model is a representation of a particular data design and is used to generate the schema for the data model the user intends to deploy. The schema provides a blueprint for the construction of the data model. This schema specifies which data will be stored in the data model in question, as well as how the data will be organized within the data model. The database schema indicates which tables or relations make up a given data model, and the fields included on each table of the database. The database schema provided by a physical data model will lay out how the data is physically stored on a storage system in terms of files and indices. In the course of importing a data model, an appropriate change request is raised via the user interface. The change request may be subject to an approval workflow as described with regard to FIG. 4.

In Step S52, after the physical data model has been imported, the user selects a database to which the data model will be applied. This database may be a new, empty dataset, or may be an existing dataset. This database will act as the target for the newly-deployed data model. Where no suitable database exists, the user may elect to create a database using the ‘Storage Asset’ function 310 of the data management software 16.

In Step S53, the user may then select an environment to which the data model will be deployed. As shown in FIG. 5b, three environments are available as default options displayed in the user interface, these environments are Dev (Development), QA (Quality Assurance), and Prod (Production). Users of the data management software 16 may create, edit or remove environments within the data management software 16. Multiple databases may be deployed to a single environment. For instance, there may be multiple instances of a QA database. The environments listed serve as labels only, denoting specific environments—the name of a given environment does not impact the location or context of the database deployed. However, the labels are useful for managing and understanding databases within the data management software. For example, databases that exist within a live production environment may be deployed to the Production environment within the data management software 16 and appear in the production environment in the user interface shown in FIG. 5b.

In Step S54, once all the necessary information has been provided, the user may initiate the process of deploying the database to the environment using the user interface. This will raise a change request, similar to the process described in relation to FIG. 2 and, optionally, FIG. 4.

Once the change request is executed, the user may use the user interface shown in FIG. 5b to migrate the schema of the database in Step S55. To migrate the database schema related to the database, a new data model is imported. The deployed database to which the imported data model is to be applied is identified using the user interface. In some embodiments, the data management software 16 may compare the current data model of the database with the new data model to be applied and provide an interface that shows differences in the tables and fields. Following user confirmation, in Step S55, the imported data model is applied to the selected database to migrate the database.

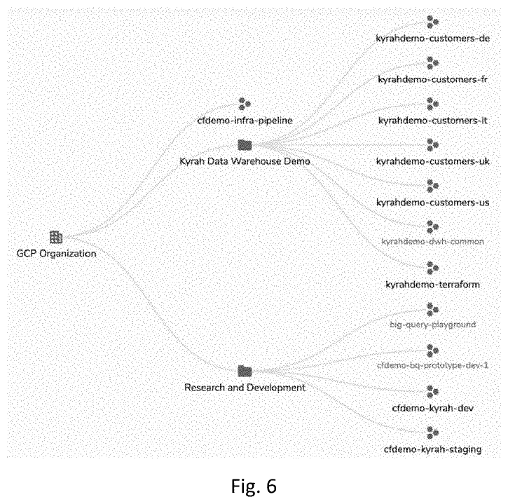

In a further embodiment, the data management software may additionally provide users with the capability to display a map of data storage assets. This allows a user to display a visual representation of data storage assets held in the cloud environment and their location. An example of such a data storage map is shown in FIG. 6. This data storage map may be viewed by selecting the appropriate ‘Storage Map’ function 308 shown on the navigation panel on the left-side of FIG. 3.

The data storage map may additionally provide a heat map functionality. This functionality causes the data storage map shown in FIG. 6 to display a visual representation of the relative usage of data storage assets held in the cloud environment 12. The data management software 16 may obtain usage logs from the data catalog and analyse the usage logs for each data storage asset 11. The usage logs may be analysed to identify which data storage assets 11 are being used most extensively. The relative usage may be displayed on the data storage map on the user interface by, for example, displaying the data storage assets 11 in different colors. The colors may be selected based on relative usage so that, for example, the 5% most often used data sets are displayed in a first color, the second 5% most often used data sets are displayed in a second color etc. As will be explained in more detail below, in embodiments where data storage asset locations are organised into tiers, the storage heat map functionality may allow a user to easily identify a more efficient use of the storage tier capability, in order to optimise storage cost.

In a further embodiment, the system described herein may additionally provide users with the capability to group storage assets together. This allows multiple data storage assets 11 to be combined into a single unified group, to which users can request access. This reduces the need for users to request access to each of a plurality of data storage assets separately, which can be time-consuming and inefficient, especially if a group of users are likely to require access to a similar set of data storage assets. In this embodiment, storage assets may be grouped together, and a single access level specified for all assets within the group. A user may then request access to the group of data storage following the procedure described with regard to FIG. 1 and be granted access to every asset within the group.

In a further embodiment, the data management software 16 may provide users with the capability to migrate data storage assets 11 between data storage locations. These data storage asset locations may be organized within the cloud environment 12 into tiers, wherein data storage assets stored in different tiers will be stored for different minimum durations. For example, standard storage may have no minimum storage duration, nearline storage may have a 30-day minimum duration and lower service levels for uptime availability, and cold-line storage may have a 90-day minimum storage duration and an even lower service level for uptime availability. The choice of storage may affect the cost of storing data and placing data into storage with lower service level requirements and longer minimum storage durations may reduce cloud data running costs. The system may provide the functionality for users to migrate data between storage tiers. When using the heat map functionality described above, the user interface may include an indication of the current storage location of some or each data storage asset on the data storage map. In this way, a user can easily see, for example, when a data storage asset is not often accessed but is stored in a more expensive high uptime storage location.

In a further embodiment, by selecting the ‘Policy engine’ function, a user may set policies that should apply to data storage assets 11 managed by the data management software 16. For example, the user interface may allow rules to be applied to access particular data storage assets. In one example, a rule may be configured that a particular data storage asset may only be accessed by a ‘service account’, where a service account is an account used by an application or virtual machine, but not by a physical user. In other examples, rules may be configured to enforce naming conventions of data assets, enforce labelling of assets, enforce setting of ownership configuration, or enforce setting of a data storage class.

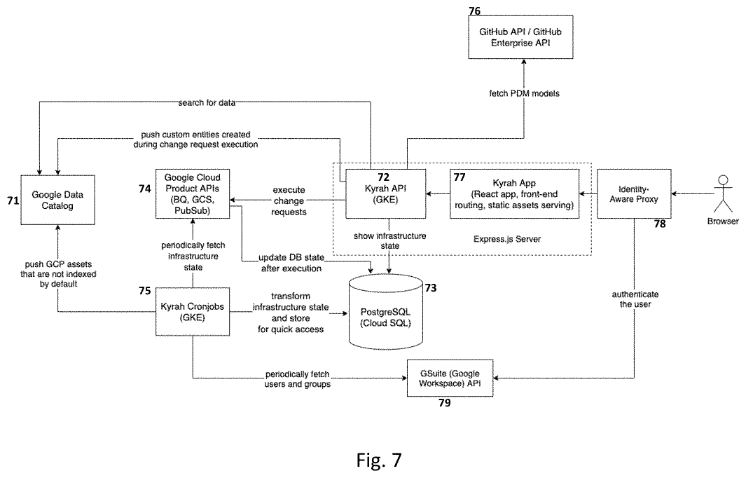

FIG. 7 is a schematic diagram of an example of software architecture suitable for carrying out the various processes described herein. While the example uses branded products, the person having ordinary skill in the art will appreciate that this is provided by way of example and that equivalent functionality may be found in different products.

The data storage assets 11 that may be viewed, requested, accessed and edited by the end user are not shown in FIG. 7, but information about the data storage assets within the Google (Registered Trademark) cloud service 12 may be stored in data catalog 71. This data catalog may be a data discovery and metadata management service operating in the cloud environment 12 and may index resources held in the cloud environment 12 as described in relation to FIG. 1, above. This data catalog 71 may be interrogated for data using system API 72. The data thus discovered may then be stored in application database 73.

System API 72 is configured to communicate with cloud-based services and data storage assets 11 through product APIs 74. It is across this connection that change requests may be executed, in order to modify data storage assets 11. Custom entities, such as newly-created data storage assets 11, may be pushed to the data catalog 71 from product API 74. Change requests requiring approval, as described above in relation to FIG. 4, may be stored in application database 73.

The application database 73 may be updated frequently. A job scheduler 75 may scan the data catalog 71 to determine whether new data storage assets 11 have been added or created and may periodically fetch information regarding infrastructure state from product APIs 74. Job scheduler 75 may then update the application database 73 with information from both sources. In this way, the application database 73 is kept up to date with the data storage assets 11 in the cloud service 12 and the metadata associated with the data storage assets 11.

Physical data models used in deploying databases to an environment, as described in relation to FIG. 5, may be imported from a version control service 76 by system API 72. Data models may subsequently be applied to databases in the cloud environment 12 by product API 74.

The data management software 16 may be operated by a user using the user interface, as described in relation to previous figures. This user interface is presented to the user through an app 77. For any change request to be initiated, system API 72 must receive an instruction from the user through the user interface. The user interface allows the user to instruct system API 72 to search the catalog 71 and enables grouping of storage assets and a visual indication of data storage. An example of a user interface presented by app 77 is illustrated in FIG. 3.

In order to maintain security, and to allow users, roles and groups within the system to be managed, an identity-aware proxy 78 is used in order to authenticate each user. This proxy 78 acts as a gateway to the app 77. A user cannot access app 77 without being authenticated by proxy 78. Managing users, roles and groups within the system is enabled by an identity provider 79 service, which provides identity data. Identity provider 79, which is part of the cloud service 12, is periodically scanned by job scheduler 75, in order to update application database 73. For example, if a user's role changes, giving them new access to certain data storage assets 11, the change in role listed in identity provider 79 is noted by job scheduler 75 during a periodic scan, and the metadata of these assets may be updated in application database 73.

Although embodiments have been described above for the purpose of illustration based on what is currently considered to be the most practical and preferred embodiments, it is to be understood that such detail is solely for that purpose and that the invention is not limited to the disclosed embodiments. For example, it is to be understood that the present invention contemplates that, to the extent possible, one or more features of any embodiment may be combined with one or more features of any other embodiment. Further not all features of each embodiment are required for operation of the data management software.

What is claimed is:

1. A computer-implemented method for managing data stores performed by an information-processing apparatus, the method comprising:
performing a discovery process to discover a plurality of data stores;
identifying each data store and determining metadata associated with each data store;
storing the metadata associated with each data store in an application database;
providing a user interface operable to select at least one discovered and identified data store and initiate a change request to modify the metadata associated with the selected data store;
executing the change request, based on an instruction received via the user interface, to modify the metadata associated with the selected data store; and
upon execution of the change request, triggering an update of the metadata in the application database associated with the selected data store.

2. A computer-implemented method according to claim 1, wherein the metadata associated with each data store comprises at least one of: permission data, schema data and policy data.

3. A computer-implemented method according to claim 1, wherein the change request comprises an access request to change access permissions for accessing the data store.

4. A computer-implemented method according to claim 1, wherein the instruction received via the user interface triggers an approval process prior to execution of the change request.

5. A computer-implemented method according to claim 4, wherein the approval process comprises causing one or more review requests to be sent and tracking receipt of one of more approvals in response to the one more review requests, wherein in a case that one or more approval is received to complete the approval process, the change request is executed.

6. A computer-implemented method according to claim 4, wherein the change request is stored in the application database until the approval process is completed.

7. A computer-implemented method according to claim 1, further comprising creating groups of discovered and identified data stores based on users having access to the data store in question.

8. A computer-implemented method according to claim 1, further comprising generating a storage map of the discovered and identified data stores.

9. A computer-implemented method according to claim 1, wherein the user interface is operable to receive instructions to cause migration of a database to a new data model.

10. A computer-implemented method according to claim 1, wherein performing a discovery process comprises interrogating a discovery function provided by a cloud service.

11. A computer-implemented method according to claim 10, wherein data store locations at which data stores are located are grouped into storage tiers according to a minimum storage duration and the method further comprises moving data stores to data store locations in different storage tiers.

12. A computer-implemented method according to claim 1, further comprising receiving an instruction defining a rule relating to metadata associated with at least one of the plurality of data stores, and comparing the discovered metadata associated with the at least one of the plurality of data stores with the defined rule.

13. An information processing apparatus comprising:
a processor, and
a storage that stores instructions that, when executed by the processor, cause the processor to perform a method comprising:
performing a discovery process to discover a plurality of data stores;
identifying each data store and determining metadata associated with each data store;
storing the metadata associated with each data store in an application database;
providing a user interface operable to select at least one discovered and identified data store and initiate a change request to modify the metadata associated with the selected data store;
executing the change request, based on an instruction received via the user interface, to modify the metadata associated with the selected data store; and
upon execution of the change request, triggering an update of the metadata in the application database associated with the selected data store.

14. A non-transitory computer-readable storage medium storing instructions that, when executed by a computer, cause it to perform a method comprising:
performing a discovery process to discover a plurality of data stores;
identifying each data store and determining metadata associated with each data store;
storing the metadata associated with each data store in an application database;
providing a user interface operable to select at least one discovered and identified data store and initiate a change request to modify the metadata associated with the selected data store;
executing the change request, based on an instruction received via the user interface, to modify the metadata associated with the selected data store; and
upon execution of the change request, triggering an update of the metadata in the application database associated with the selected data store.
